(19) United States
(12) Patent Application Publication
(10) Pub. No.: US 2004/0121880 A1
(43) Pub. Date: Jun. 24, 2004

(54) Continuously variable toroidal gear

(76) Inventor: J?uuml;rgen Wafzig, (US)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/476,469

(22) PCT Filed: Apr. 27, 2002
(86) PCT No.: PCT/EP02/04687

(30) Foreign Application Priority Data
May 3, 2001 (DE) 101 21 489.8

(51) Int. Cl. F16H 15/38

(52) U.S. Cl. 476/40

(57) ABSTRACT

A continuously variable friction gear with two gear units is so designed that the two supports of each gear unit are connected to one another in each case by endless chains extending at an angle to the longitudinal axis of the continuously variable friction gear, in such manner that one chain loops round the first (front) support of the first gear unit and the second (rear) support of the second gear unit, and the other chain loops round the second (front) support of the first gear unit and the first (rear) support of the second gear unit, and each endless chain is associated with a control device which is arranged outside the chain and acts upon the outside of the latter with an adjustable force.

The present invention concerns a continuously variable friction gear according to the preamble of claim 1.

A continuously variable friction gear of this type usually comprises input and output disks arranged coaxially on a common shaft. The disks are arranged in pairs with one another and have inner surfaces designed with a toroidal shape, with friction wheels arranged between the pairs of input and output disks. These friction disks are in frictional contact with both the input disks and the output disks, and transfer the torque transferred to them by the input disks to the output disks by frictional contact, the rotation speed of the friction wheels becomes higher, as the distance between their contact point with the input disks and the rotation axis becomes greater. In contrast, the rotation speed of the output disks is higher, as their point of contact with the friction wheel to the rotation axis is closer. By swivelling the friction wheels, the rotation speed of the output disks can accordingly be adjusted infinitely variably and in any desired way. For this purpose the rotation axles of the friction wheels are in each case mounted on a support which can be controlled by a swivelling device.

Such a continuously variable friction gear is described in detail in DE 197 54 725 by the present applicant. This gear system contains two gear units arranged coaxially on the input shaft, each gear unit comprising an input and an output disk between which two friction wheels are respectively arranged, each friction wheel being fixed on a swivelling support. Both the input and output disks are mounted on a torque shaft, which can be displaced slightly in the axial direction relative to the input shaft. The input disk of one gear unit is attached rotationally fast to the torque shaft, but mounted on it so that it can slide. The input disk of the other gear unit is also connected rotationally fast relative to the torque shaft by means of gear teeth. The two output disks of the two gear units are arranged mirror-symmetrically to one another and next to one another in the gear system and on a common bush, so that the torques transferred from one input disk to its associated output disk from the other input disk to its associated output disk, are transferred by the two output disks, both connected rotationally fast with the bush, to a gear wheel which meshes with a gear wheel of an output shaft. A roller-shaped pressure device acts on one of the input disks, which is mounted on the input shaft and can be axially displaced on it and is in rotationally fast connection with it.

In this known continuously variable friction gear the transmission ratio is usually adjusted by displacing the friction wheels tangentially to the transmission axis, during which, however, swivelling forces act from the input and output shafts on the friction wheel positioned between them, since to transfer the torque the latter have to be pressed against the friction wheel. In conventional continuously variable gear systems the friction wheel in each gear unit is arranged in such manner that its swivel axis is located at the mid-point of the torus formed by the associated input and output disks. At the contact points between the friction wheel and the associated input and output disks, so-termed normal forces are therefore produced during the adjustment of the transmission ratio.

To prevent the possibility that if the normal forces occurring during the transmission ratio adjustment are unequal, the torque on the friction wheel caused by this might bring about an undesired transmission ratio change, in DE 198 26 057 by the present applicant it has already been proposed to compensate any difference of the normal forces by producing a control force, such that when the friction wheel is axially fixed this control force, which leads to tilting of the friction wheel, can be applied to one of the two associated disks, while when one of the disks is axially fixed the control force acts on the friction wheel.

It has also already been proposed to support the friction wheels in a continuously variable friction gear by means of two connecting rods, which counteract the reaction forces occurring. For this, the swivelling movement of the friction wheels is made possible by roller bearings; this design, however, has the disadvantage that the weight of the friction gear is large and there is no coupling of the swivel movements of the two friction wheel supports arranged in one gear unit.

In these known friction gear systems it is usual for the tilt angle of only one support to be controlled, while the other support is acted upon by the identical pressure.

The purpose of the present invention is to further develop the design of a friction gear in such manner that the tilt angle between the friction wheel supports is freely adjustable, on the one hand to achieve effective synchronization between the supports during the (rapid) adjustment processes, and on the other hand to provide the supports and so too therefore the friction wheels with the necessary clearance, i.e., freedom of movement, so that the supports can be adjusted free of forces and can run with optimum efficiency in accordance with the tolerances and load distribution.

These objectives are achieved by the features indicated in the characterizing portion of claim 1; advantageous embodiments are described in the subordinate claims.

According to the invention it is thus proposed that the two supports of each gear unit are connected to one another by means of two endless chains extending each at an angle to the longitudinal axis of the friction gear, in such manner that one chain is looped round the first (front) support of the first gear unit and the second (rear) support of the second gear unit, while the other chain is looped round the second (front) support of the first gear unit and the first (rear) support of the second gear unit, so that the two endless chains cross between the four supports and each endless chain is associated with a control device arranged inside or outside the chain, and which acts upon it with an adjustable force.

Advantageously, the chains with their respective associated supports can be displaced axially but are connected fast in relation to torque. The axially displaceable and torque-fixed connection can preferably be a ball carrier on the support.

Preferably, the axial displacement of the chains in torque-fixed connection with the supports takes place by action upon the transverse elasticity of the chains.

The control device arranged outside the endless chain and in active engagement with it is preferably a swivelling lever, one end of which is mounted to rotate and can be displaced slightly and the other end of which, which acts upon the outside of the endless chain with an adjustable force, is connected to a toothed wheel adapted to the dimensions of the individual chain links, which is suspended and can rotate freely.

The force for adjusting the swivelling lever to compensate the stroke of the support can be applied either hydraulically, or mechanically, or electrically, or pneumatically.

Thus, the friction gear designed according to the invention achieves the advantage of variable adjustment and synchronization of the supports associated respectively with two separate gear units by virtue of adjustable chain tensioning or relaxation by means of the control device. In this, the two chains are synchronized by a transmission ratio control device 52. This comprises essentially an axle with two toothed wheels on two different planes.

Below, the invention is explained in more detail with reference to the drawing, in which an advantageous example embodiment is illustrated and which shows:

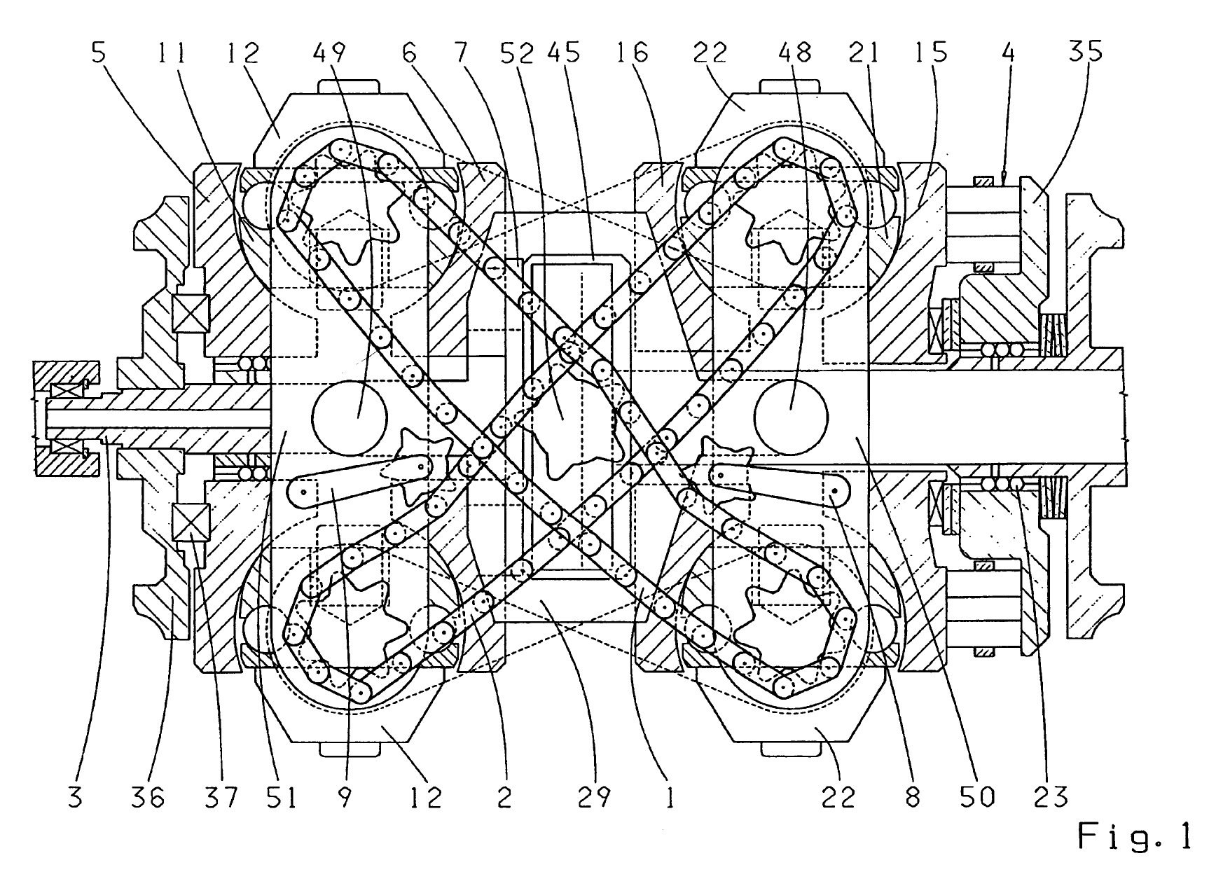

FIG. 1 is a schematic view of a continuously variable friction gear showing the arrangement of the endless chains; and

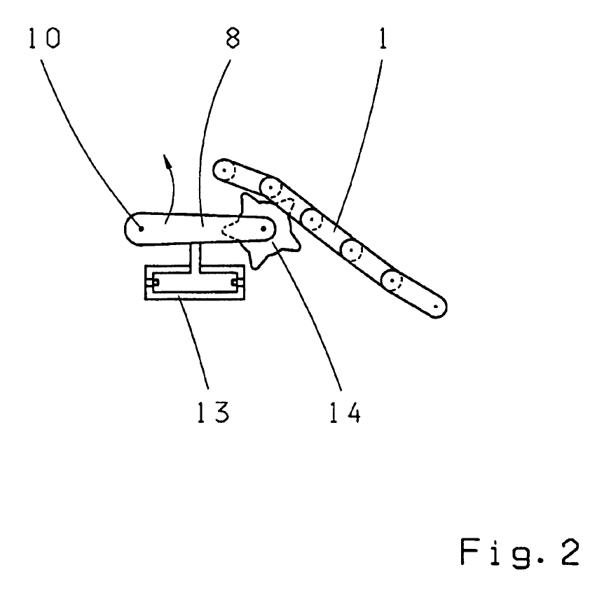

FIG. 2 is an example embodiment of a control device for an endless chain.

The continuously variable friction gear illustrated schematically in FIG. 1 with two gear units corresponds in its structure to that described as an example in DE 197 36 830 by the present inventor. An input shaft 3 of the friction gear is connected to a starting element (not shown), for example a torque converter or a wet-operating getaway clutch of a drive motor of a motor vehicle. Coaxially with the input shaft 3 are arranged two gear units, one of the said gear units having an input disk 5 and an output disk 6 whose surfaces facing one another are designed in a toroid shape. The other gear unit has an input disk 15 and an output disk 16 arranged opposite it, whose surfaces facing one another are also designed in a toroid shape. In the two gear units, respectively, two friction wheels 11, 21 are provided, which are attached to swivelling supports 12 and 22 such that they can swivel relative to the longitudinal axis of the input shaft 3. The respective friction wheels 11, 21 are in friction-force contact with the two inwards-facing surfaces of the input disks 5, 15 and the output disks 6, 16, with the friction wheels of a gear unit arranged symmetrically relative to the axis of the input shaft 3.

The usual roller-shaped pressure device is indexed as 4, a bearing support element 7, a bearing 23, a frame bracket 29, a disk with a curved-track 35, an axial disk 36, a bearing 37, a cut-out 45, two pins 48 and 49, and two crossbars 50 and 51.

If the friction wheels 11, 21 are now inclined relative to the longitudinal axis of the input shaft, the points of contact of the circumference of the friction wheels 11, 21 is displaced along the toroidal surfaces of both the input and the output disks, as a result of which the transmission ratio between an input and an output disk can be adjusted continuously, i.e., with infinite variability.

To be able now to adjust freely the tilt angle between the supports, in order on the one hand to ensure effective synchronization between the supports and hence also the friction wheels during rapid adjustment processes, and on the other hand to allow the necessary play of the supports and hence also of the friction wheels, so that the supports can be adjusted without force in accordance with the manufacturing tolerances and the load distribution and can therefore run with optimum efficiency, according to the invention two endless chains 1, 2 are provided, which extend diagonally respectively from the left front support 12 to the right rear support 22 and from the right front support 22 to the left rear support 12 as shown in FIG. 1, and this in such manner that each chain loops around the two supports associated with it, such that they cross between the pairs of supports but without mutual contact. The two chains 1, 2 are synchronized with one another by virtue of a transmission ratio control device 52; the two chains 1, 2 can be connected to the supports 12, 22 by an axially displaceable but torque-fixed connection, in particular by a ball drive. It is particularly cost-effective and advantageous for the connection of the endless chains 1, 2 to the supports 12, 22 to be fixed and for the compensation of the support stroke (which is usually less than 5 mm) to be effected by virtue of the transverse elasticity of the endless chains or the individual chain links. In the figure the chains are shown in a not completely tensioned condition in order to make the illustration more clearly understandable; according to the invention, however, the toothed wheels shown engage in the chain links.

Two control devices indexed as 8, 9 are arranged outside the associated endless chains 1, 2 in such manner that they act upon the outside of the associated endless chain 1, 2 with an adjustable force. Depending on the swivelling movement of the control device, the corresponding endless chain is tensioned to a greater or lesser extent, whereby the rotational play between the supports can be adjusted. The control devices can also be arranged within the endless chains. As a variant of the present invention, two or more control devices can be provided per chain.

FIG. 2 shows an example embodiment of the control device 8, 9 which consists of a swivelling lever mounted on a pivot 10, whose other end associated with the endless chain 1 is provided with a freely rotatable toothed wheel 14 which engages with the chain links and is adapted to them. The lever can be moved hydraulically, as indicated schematically by a hydraulic piston 13. The arrow in the Figure indicates the swivelling movement. It is just as well possible to move the swivelling lever 10 by mechanical means with a predetermined force in order to adjust the tension of the chain 1. The higher this tension of the chain is, the smaller the rotational play between the associated supports is.

### Reference Numerals

1 Endless chain

2 Endless chain

3 Input shaft

4 Pressure device

5 Input disk

6 Output disk

7 Bearing support element

8 Control device

9 Control device

10 Pivot

11 Friction wheel

12 Support

13 Hydraulic piston

14 Toothed wheel

15 Input disk

16 Output disk

21 Friction wheel

22 Support

23 Bearing

29 Frame bracket

35 Curved-track disk

36 Axial disk

37 Bearing

45 Cut-out

48 Pin

49 Pin

50 Crossbar

51 Crossbar

52 Transmission ratio control device

1. Continuously variable friction gear with:
an input shaft,
two input disks (5, 15) arranged coaxially with the input shaft, having toroid-shaped inner surfaces,
two output disks (6, 16) arranged coaxially with the input shaft, having toroid-shaped inner surfaces, such that in each case one input disk and one output disk form a pair and the two output disks are arranged mirror-symmetrically to one another and next to one another,
several friction wheels (11, 21) arranged between the inner surfaces of the input/output disk pairs and able to tilt between them in order to transfer a torque from the input disk to the associated output disk,
a support (12, 22) for each friction wheel (11, 21),
a pressure device (4) for pushing the input disks towards the output disks in order to produce the torque-dependent axial force, and
a swivelling device for the friction wheel supports,
characterized in that the supports of the two gear units are connected to one another by two endless chains (1, 2) extending each at an angle to the longitudinal axis of the continuously variable friction gear, in such manner that a chain (2) loops round the first (front) support (12) of the first gear unit and the second (rear) support (22) of the second gear unit, and the other chain (1) loops round the second (front) support (12) of the first gear unit and the first (rear) support (22) of the second gear unit (as shown in FIG. 1), so that the two endless chains (1, 2) cross between the supports but do not touch one another, and each endless chain (1, 2) is associated with at least one control device (8, 9) arranged within or outside the chain and which acts upon the chain with an adjustable force, such that the endless chains (1, 2) are synchronized with one another.

2. Continuously variable friction gear according to claim 1, characterized in that the endless chains (1, 2) are connected to their respective associated supports (12, 22) so that they can be axially displaced but are fixed in relation to torque.

3. Continuously variable friction gear according to claim 2, characterized in that the axially displaceable but torque-fixed connection is a ball drive on the support (12, 22).

4. Continuously variable friction gear according to any of the preceding claims, characterized in that the endless chains (1, 2) are connected in a torque-fixed way to their respective associated supports (12, 22) and the axial displacement takes place by virtue of the transverse elasticity of the endless chains (1, 2).

5. Continuously variable friction gear according to any of the preceding claims, characterized in that the control device (8, 9) consists of a swivelling lever, one end of which is mounted to rotate on a pivot (10) and the other end of which, that acts on the outside of the endless chain (1, 2) with a predetermined force, is provided with a toothed wheel (14) arranged on the swivelling lever and able to rotate freely on it, which engages in the endless chain (1).

6. Continuously variable friction gear according to any of the preceding claims, characterized in that the control device (8, 9) is swivelled by a hydraulic piston (13).

7. Continuously variable friction gear according to any of the preceding claims, characterized in that the control device (8, 9) is swivelled by a mechanical displacement device.

8. Continuously variable friction gear according to any of the preceding claims, characterized in that the control device (8, 9) is swivelled by an electrical displacement device.

9. Continuously variable friction gear according to any of the preceding claims, characterized in that the control device (8, 9) is swivelled by an electromechanical displacement device.

10. Continuously variable friction gear according to any of the preceding claims, characterized in that the control device (8, 9) is swivelled by a pneumatic displacement device.

11. Continuously variable friction gear according to any of the preceding claims, characterized in that the control device (8, 9) is arranged within the chain.

12. Continuously variable friction gear according to any of the preceding claims, characterized in that the endless chains (1, 2) are synchronized with one another by means of a transmission ratio control device (52).

13. Continuously variable friction gear according to claim 12, characterized in that the transmission ratio control device comprises an axle with two gearwheels on two different planes.
